(19) United States
(12) Patent Application Publication
(10) Pub. No.: US 2026/0051667 A1
(43) Pub. Date: Feb. 19, 2026

(54) WAVEGUIDE INTEGRATED SUBSTRATES AND WAVEGUIDE ARRAY ANTENNA APPARATUS

(71) Applicant: AGENCY FOR DEFENSE DEVELOPMENT, Daejeon (KR)

(72) Inventors: Ji Haeng CHO, Daejeon (KR); Kyoung Youl PARK, Daejeon (KR); Chul Min LIM, Daejeon (KR); Sang Kil KIM, Busan (KR); Ho Yong KIM, Busan (KR); Gyoung Deuk KIM, Busan (KR)

(21) Appl. No.: 19/082,741

(22) Filed: Mar. 18, 2025

(30) Foreign Application Priority Data
Aug. 19, 2024 (KR) 10-2024-0110602

(51) Int. Cl. H01Q 21/06; H01Q 9/04; H01Q 13/02

(52) U.S. Cl. CPC H01Q 21/064; H01Q 9/0414; H01Q 13/0241

(57) ABSTRACT

Provided is an antenna substrate including a first substrate including a feed line and a drive patch carrying a signal received via the feed line, a second substrate laminated on top of the first substrate and including a plurality of laminated patches carrying the signal and a plurality of first pads disposed outside of the plurality of laminated patches, and a third substrate laminated on top of the second substrate and including a plurality of second pads coupled to the plurality of first pads.

### PRIORITY INFORMATION

This application claims the benefit of Korean Patent Application No. 10-2024-0110602, filed on Aug. 19, 2024, in the Korean Intellectual Property Office, which is hereby incorporated herein by reference in its entirety.

### FIELD OF THE INVENTION

The example embodiments generally relate to wireless communications, and more particularly to a waveguide integrated substrate and a waveguide array antenna apparatus.

### DESCRIPTION OF THE RELATED ART

Antenna apparatuses are essential components in wireless communications that allow information to be transmitted over a distance in the form of electromagnetic waves with a specific frequency wirelessly. In particular, when it comes to satellite communications, antenna apparatuses are required to have high gain and features such as beam steering. In order for antenna apparatuses mounted on communication satellites to have high gain and beam steering, the array design of antenna apparatuses is essential.

In general, communication satellites use high-powered signal sources to secure high effective isotropic radiated power (EIRP), and waveguide structures are used to efficiently carry high-powered signals generated from high-powered signal sources. In this case, active beam steering technology is used to maximize the communication time to match the movement of the fast-moving communication satellite, and for this purpose, active circuits for active beam steering are mounted on flat PCB substrates to adjust the phase of the signal.

However, in a typical waveguide structure, the response speed and mechanical errors of the beam steering technology cause time delays and phase errors, which are critical for next-generation communication technologies. In addition, the waveguide structure does not use the transverse electromagnetic wave (TEM) mode, which poses great difficulties in mounting active circuits on PCB substrates.

### SUMMARY

Accordingly, the embodiments of the present invention substantially obviate one or more problems due to limitations and disadvantages of the related art.

An aspect provides an antenna substrate having a waveguide integrated structure capable of having a large fractional bandwidth by regulating the distribution of an electric field.

Another aspect provides a broadband high gain antenna apparatus and a device capable of simultaneously radiating and receiving dual circularly polarized waves.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

According to an aspect, there is provided an antenna substrate including a first substrate including a feed line and a drive patch carrying a signal received via the feed line, a second substrate laminated on top of the first substrate and including a plurality of laminated patches carrying the signal and a plurality of first pads disposed outside of the plurality of laminated patches, and a third substrate laminated on top of the second substrate and including a plurality of second pads coupled to the plurality of first pads.

According to an example embodiment, the plurality of second pads may be disposed on a third coupling surface of the third substrate where an upper surface of the third substrate is coupled to a waveguide, the plurality of laminated patches and the plurality of first pads may be formed to protrude upwardly on the second substrate to correspond to the third coupling surface, and the drive patch may be disposed on a first coupling surface of the first substrate corresponding to the third coupling surface.

According to an example embodiment, the first coupling surface and the third coupling surface may be square planes, the plurality of second pads may be disposed to correspond to corners of the third coupling surface, and the plurality of first pads may be disposed on the second substrate to correspond to positions of the plurality of second pads.

According to an example embodiment, the plurality of first pads and the plurality of second pads may be coupled through vias.

According to another aspect, there is provided an antenna apparatus including a waveguide in the form of a square column extending in a first direction, and a horn antenna located inside the waveguide in a coaxial configuration with the waveguide and including a septum. The septum is formed based on a cross-section on the first direction side of the horn antenna to connect between two cross-sections of the horn antenna facing each other in a second direction perpendicular to the first direction along the second direction.

According to an example embodiment, the septum may include a plurality of septum interior space portions extending to different lengths in the first direction from the cross-section of the horn antenna where the septum is formed.

According to an example embodiment, the length of each of the plurality of septum interior space portions extending in the first direction may be formed to increase in the order in which the plurality of septum interior space portions are located along the second direction.

According to an example embodiment, the horn antenna may further include a ridge recessed from a lower surface of the horn antenna in an inward direction of the horn antenna and coupled to a lower surface of the septum.

According to an example embodiment, the antenna apparatus may further include a first input port and a second input port formed to be symmetrical to each other with respect to the septum corresponding to the cross-section where the septum of the horn antenna is formed.

According to yet another aspect, there is provided a device including a plurality of antenna apparatuses, and an antenna substrate coupled to the plurality of antenna apparatuses and feeding the plurality of antenna apparatuses. Each of the plurality of antenna apparatuses includes a horn antenna including a septum, and a first input port and a second input port formed to be symmetrical to each other with respect to the septum corresponding to the cross-section where the septum of the horn antenna is formed. The antenna substrate is formed of a plurality of sub-antenna substrates coupled in one-to-one correspondence with input ports of each of the plurality of antenna apparatuses, and each of the plurality of sub-antenna substrates is coupled to a corresponding input port through a waveguide.

According to an example embodiment, each sub-antenna substrate of the antenna substrate corresponding to the first input port of each of the plurality of antenna apparatuses may be disposed outside of each sub-antenna substrate corresponding to the second input port of each of the plurality of antenna apparatuses.

Antenna substrates, antenna apparatuses, and devices including them, according to example embodiments disclosed herein, can carry high-powered signals with a large fractional bandwidth by regulating the distribution of an electric field. Furthermore, dual circularly polarized waves can be simultaneously radiated and received, and wide bandwidth and high gain can be achieved.

In addition, various other effects can be provided that are directly or indirectly identified in this disclosure. It is to be understood that both the foregoing general description and the following detailed description are examples and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram illustrating a structure of an antenna substrate according to an example embodiment disclosed herein;

FIG. 2 is a diagram illustrating an integrated structure of an antenna substrate and a waveguide according to an example embodiment disclosed herein;

FIG. 3 is a diagram illustrating an example cross-sectional view of a laminated structure of an antenna substrate according to an example embodiment disclosed herein;

FIGS. 4A and 4B are diagrams illustrating an example distribution of an electric field formed on an antenna substrate according to an example embodiment disclosed herein;

FIG. 4C is a diagram illustrating an example distribution of an electric field formed in a waveguide according to an example embodiment disclosed herein;

FIGS. 5A and 5B are diagrams illustrating example results of evaluating an antenna substrate according to an example embodiment disclosed herein;

FIG. 6 is a diagram illustrating a structure of an antenna apparatus according to an example embodiment disclosed herein;

FIG. 7 is a diagram illustrating an example of circularly polarized waves being formed in an antenna apparatus according to an example embodiment disclosed herein;

FIG. 8 is a diagram illustrating an example of an antenna apparatus including a ridge according to an example embodiment disclosed herein;

FIG. 9 is a diagram illustrating an example of an antenna apparatus including a first input port and a second input port according to an example embodiment disclosed herein;

FIG. 10 is a diagram illustrating the difference in magnitude of signals generated in TE10 mode and TE01 mode with and without a ridge according to an example embodiment disclosed herein;

FIG. 11 is a diagram illustrating an example of a device according to an example embodiment disclosed herein;

FIG. 12 is a diagram illustrating an example arrangement of antenna apparatuses according to an example embodiment disclosed herein;

FIG. 13 is a diagram illustrating an example of a performance evaluation according to an arrangement of apparatuses according to an example embodiment disclosed herein; and FIGS. 14A and 14B illustrate example frequency-dependent gains of a device according to an example embodiment disclosed herein.

### DETAILED DESCRIPTION

Reference will now be made in detail to the embodiments of the present invention, examples of which are illustrated in the accompanying drawings. However, this is not intended to limit the present disclosure to any particular example embodiment and should be understood to include various modifications, equivalents, and/or alternatives of the example embodiments of the present disclosure.

As used herein, the singular form of a noun corresponding to an item may include one or more of those items, unless the relevant context clearly dictates otherwise. As used herein, each of the phrases “A or B,” “at least one of A and B,” “at least one of A or B,” “A, B or C,” “at least one of A, B and C,” and “at least one of A, B or C” may include any of the items listed together in that phrase, or any possible combination thereof. Terms such as “first” and “second” may be used simply to distinguish one such component from another, and do not limit such components in any other respect (e.g., importance or order). Where a component (e.g., a first component) is referred to as being “coupled” or “connected” to another component (e.g., a second component), with or without the terms “functionally” or “communicatively,” it is intended to mean that the component may be connected to the other component directly (e.g., by wire), wirelessly, or through a third component.

Each component (e.g., module or program) of the components described herein may include a single or plurality of entities. According to various example embodiments, one or more components or operations of such components may be omitted, or one or more other components or operations may be added. Alternatively or additionally, a plurality of components (e.g., modules or programs) may be integrated into a single component. In such a case, the integrated component may perform one or more functions of each of the components of the plurality of components the same or similar to those performed by that component of the plurality of components prior to the integration. According to various example embodiments, the operations performed by a module, program, or other component may be executed sequentially, in parallel, iteratively, or heuristically, or one or more of the operations may be executed in a different order, omitted, or one or more other operations may be added.

As used herein, the term “module” or “ . . . part” may include a unit implemented in hardware, software, or firmware, and may be used interchangeably with terms such as, for example, logic, logic block, component, or circuit. A module may be an integrally organized part or a minimal unit or portion of that part for performing one or more functions. For example, according to an example embodiment, a module may be implemented in the form of an application-specific integrated circuit (ASIC).

Various example embodiments of the present disclosure may be implemented as software (e.g., a program or application) including one or more instructions stored on a storage medium (e.g., memory) readable by a machine. For example, a processor of a machine may call at least one of the one or more instructions stored on the storage medium and execute it. This enables the machine to be operable to perform at least one function in accordance with the at least one instruction called. The at least one instruction may include code generated by a compiler or code that may be executed by an interpreter. The machine-readable storage medium may be provided in the form of a non-transitory storage medium. As used herein, “non-transitory” means only that the storage medium is a tangible device and does not include signals (e.g., electromagnetic waves), and the term does not distinguish between cases where data is stored on the storage medium on a semi-permanent basis and cases where the data is stored on a temporary basis.

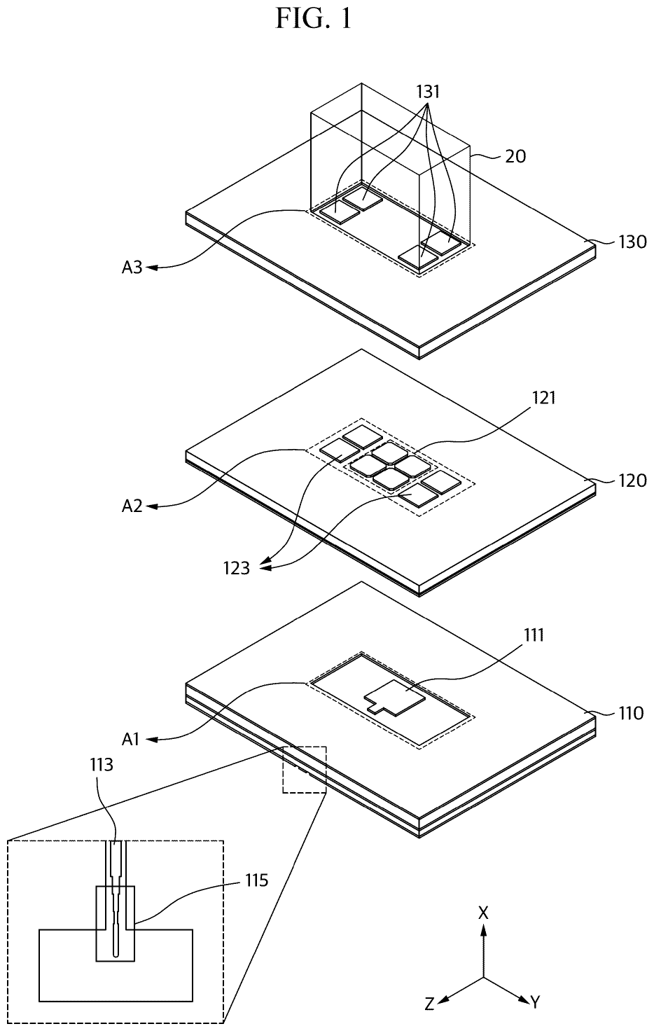

FIG. 1 is a diagram illustrating a structure of an antenna substrate according to an example embodiment disclosed herein.

The antenna substrate according to an example embodiment disclosed herein may have a high fractional bandwidth of greater than 40% and not have a back cavity by regulating the electric field distribution utilizing a radial structure and stacked patches.

Referring to FIG. 1, the antenna substrate may include a first substrate 110, a second substrate 120, and a third substrate 130. The antenna substrate may be formed by laminating the first substrate 110, the second substrate 120, and the third substrate 130. For example, the first substrate 110, the second substrate 120, and the third substrate 130 may be sequentially stacked in the z-axis direction of FIG. 1.

The antenna substrate may be a substrate for operating, for example, in the X/Ku band for satellite communications, i.e., in the frequency band of 10 to 16 GHz. However, the frequency band described above is exemplary and the antenna substrate may operate in other frequency bands, such as the Ka band.

The antenna substrate may carry high-powered high-frequency signals received via a feed line 113 with minimal loss to a waveguide 20 that is integrated with the antenna substrate. Additionally, the antenna substrate may operate in combination with an antenna apparatus described later.

The first substrate 110 may include the feed line 113 and a drive patch 111 that carries signals received over the feed line 113. The feed line 113 may provide power and/or signals to the antenna substrate from outside the antenna substrate. For example, signals from a high-powered signal source may be provided to the antenna substrate via the feed line 113.

According to an example embodiment, the first substrate 110 may include an active circuit 115 in connection with the feed line 113 to adjust the phase of the signal. The active circuit 115 may be subject to a beam steering technique that adjusts the phase of the signal to increase the communication time when the antenna substrate is coupled with an antenna apparatus to perform communication.

The drive patch 111 may carry signals received over the feed line 113. More specifically, the drive patch 111 may carry a signal that is received over the feed line 113 and phase-adjusted by the active circuit 115. The drive patch 111 may carry the phase-adjusted signal to the second substrate 120 that is laminated on top of the first substrate 110.

The second substrate 120 is laminated on top of the first substrate 110, and may include a plurality of laminated patches 121 carrying signals, and a plurality of first pads 123 disposed outside of the plurality of laminated patches. The plurality of laminated patches 121 may carry signals from the drive patch 111 to the top of the second substrate 120 with minimal loss. To this end, the plurality of laminated patches 121 may be arranged in a radial structure.

The plurality of first pads 123 may be disposed outside of the plurality of laminated patches 121. The plurality of first pads 123 may be configured to prevent loss of signal as the signal is transmitted through the plurality of laminated patches 121. That is, the plurality of first pads 123 may be structures for regulating the distribution of the electric field of the signal transmitted through the plurality of laminated patches 121.

For example, the plurality of first pads 123 may each be a rectangular-shaped structure, which may regulate the electric field delivered from the plurality of laminated patches 121 not to disperse outside of the plurality of first pads 123. In other words, the plurality of first pads 123 may regulate the distribution of the electric field such that the electric field is concentrated in the region where the plurality of laminated patches 121 are located by preventing the electric field from dispersing outwardly.

The third substrate 130 is laminated on top of the second substrate 120 and may include a plurality of second pads 131 coupled to the plurality of first pads 123. The plurality of second pads 131, like the plurality of first pads 123, may be configured to regulate the distribution of the electric field.

For example, the plurality of second pads 131 may each be the same type of structure as the plurality of first pads 123 and, like the plurality of first pads 123, may serve to prevent the electric field from dispersing outwardly as the signal is delivered.

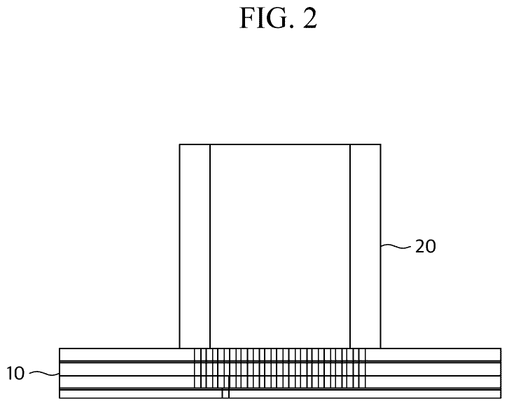

The third substrate 130 may have a waveguide 20 coupled to its top surface. Signals delivered from the plurality of laminated pads 121 of the second substrate 120 may be transmitted to an external device (e.g., an antenna) via the waveguide 20 coupled to the third substrate 130. For example, as shown in FIG. 2, the waveguide 20 may be coupled to the top of the antenna substrate 10.

The waveguide 20 may refer to a hollow tube made of a conductor, and may refer to a passageway for signals to travel through. The waveguide 20 may have a hollow polygonal or hollow columnar shape. For example, the waveguide 20 may have a square column shape.

As described above, the antenna substrate may regulate the electric field of the signal transmitted through the plurality of first pads 123 and the plurality of second pads 131 so that high-powered high-frequency signals provided over the feed line 113 may be transmitted to the waveguide 20 with minimal loss.

According to an example embodiment, the plurality of second pads 131 may be disposed on a third coupling surface A3 of the third substrate 130 where the upper surface of the third substrate 130 is coupled to the waveguide 20. The third coupling surface A3 may be a portion of the upper surface of the third substrate 130, and may refer to a portion where the lower surface of the waveguide 20 is coupled to the third substrate 130.

The plurality of second pads 131 may be disposed on the third coupling surface A3 corresponding to the lower surface of the waveguide 20 through which the signal is transmitted, thereby regulating the electric field so that the signal is not dispersed outside of the third coupling surface A3 and is transmitted into the waveguide 20 with minimal loss.

For example, the plurality of second pads 131 may be spaced apart from each other, and may be formed to have a regular arrangement.

The plurality of laminated patches 121 and the plurality of first pads 123 may be formed to protrude above the upper surface of the second substrate 120 to correspond to the third coupling surface A3. For example, the plurality of laminated patches 121 and the plurality of first pads 123 may be formed to protrude upwardly on the second substrate 120 from a second coupling surface A2, which is part of the upper surface of the second substrate 120, corresponding to the third coupling surface A3.

Like the plurality of second pads 131, the plurality of first pads 123 may be formed to correspond to the lower surface of the waveguide 20 through which the signal is transmitted, thereby regulating the electric field so that the signal is not dispersed outside of the second coupling surface A2 and is transmitted into the waveguide 20 with minimal loss.

For example, the plurality of first pads 123 may be spaced apart from each other, and may be formed to have a regular arrangement.

The drive patch 111 may be disposed on a first coupling surface A1 of the first substrate 110 corresponding to the third coupling surface A3. That is, the first coupling surface A1 and the third coupling surface A3 may be planes having the same coordinates in the x and y axes, with only the z-axis coordinates being different.

The drive patch 111 may be disposed on the first coupling surface A1 to deliver the signal toward the waveguide 20. For example, the drive patch 111 may be disposed to correspond to the center of the lower surface of the waveguide 20.

According to an example embodiment, the first coupling surface A1 and the third coupling surface A3 may be square planes. The first coupling surface A1 and the third coupling surface A3 may be formed to fit the structure of the waveguide 20 being coupled to the antenna substrate, and as the waveguide 20 is configured in the form of a square column, the first coupling surface A1 and the third coupling surface A3 may be square planes.

According to an example embodiment, the plurality of second pads 131 may be disposed to correspond to the edges of the third coupling surface A3, and the plurality of first pads 123 may be disposed on the second substrate 120 to correspond to the positions of the plurality of second pads 131. By being positioned in this manner, the plurality of first pads 123 and the plurality of second pads 131 may regulate the electric field of the transmitted signal to minimize loss of the signal.

According to an example embodiment, the plurality of first pads 123 and the plurality of second pads 131 may be connected through vias. For example, each pad included in the plurality of first pads 123 and the plurality of second pads 131 may include a through-hole. Then, the plurality of first pads 123 and the plurality of second pads 131 may be connected through vias between the through-holes of the corresponding pads.

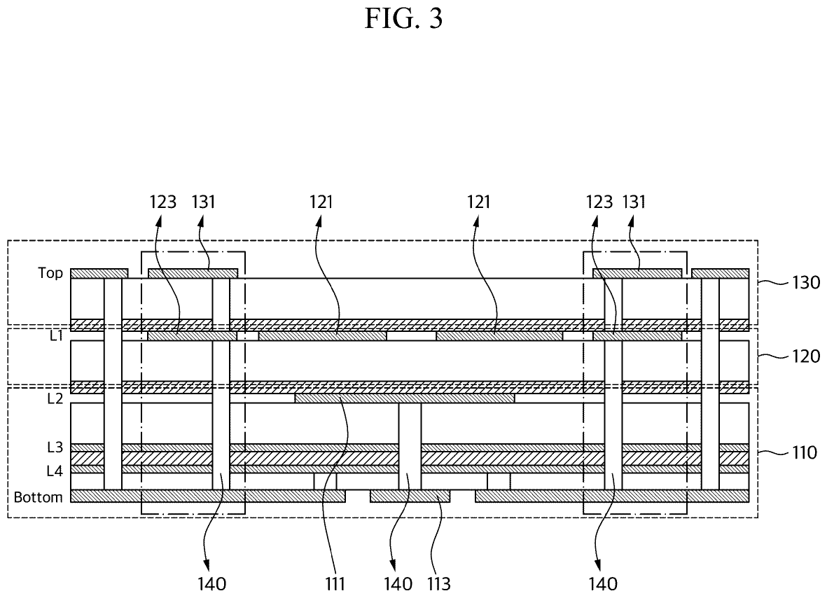

FIG. 3 is a diagram illustrating an example cross-sectional view of a laminated structure of an antenna substrate according to an example embodiment disclosed herein. FIG. 3 shows an example of a cross-section cut in a plane parallel to the lamination direction of an antenna substrate 10.

Referring to FIG. 3, the antenna substrate 10 may include a first substrate 110, a second substrate 120, and a third substrate 130. The antenna substrate 10 may include a plurality of layers, and each of the first substrate 110 and the third substrate 130 may include at least one layer.

For example, the first substrate 110 may include a bottom layer (Bottom), a fourth layer (L4), a third layer (L3), and a second layer (L2). The bottom layer (Bottom) may have a feed line 113 formed therein, and the second layer (L2) may have a drive patch 111.

The second substrate 120 may include a first layer (L1), and a plurality of laminated patches 121 and a plurality of first pads 123 may be formed in the first layer (L1).

The first substrate 110 may include a top layer (Top), and a plurality of second pads 131 may be formed in the top layer (Top). Further, an outer surface structure may be formed on the top layer (Top) to protect the antenna substrate 10.

Further, the plurality of first pads 123 and the plurality of second pads 131 may be connected through vias 140. Similarly, the drive patch 111 and the feed line 113 may also be connected through the vias 140.

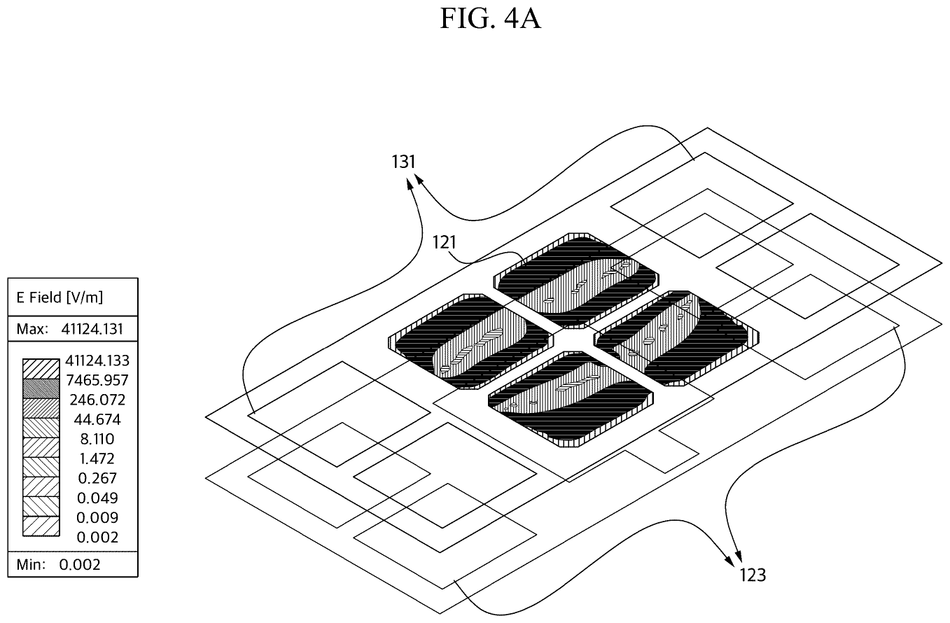

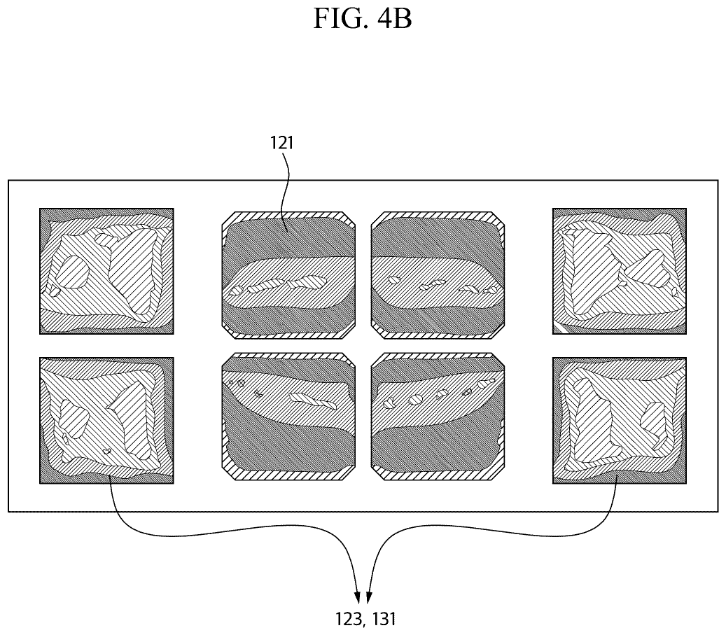

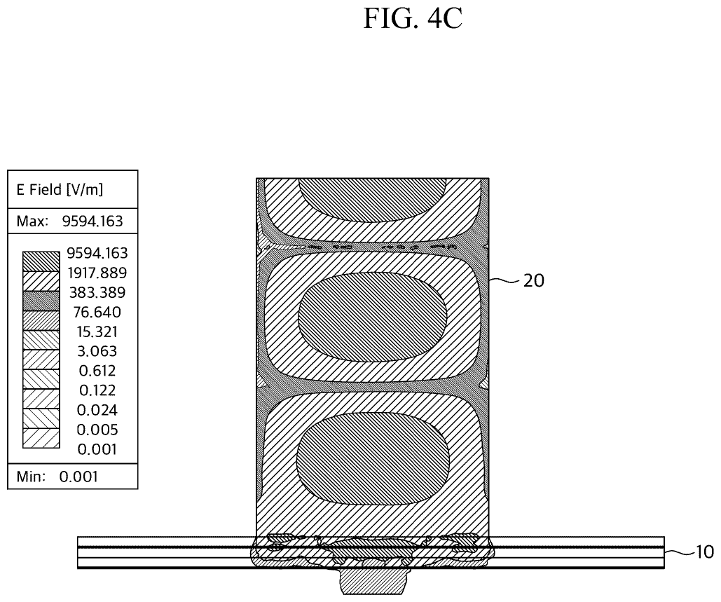

FIGS. 4A and 4B are diagrams illustrating an example distribution of an electric field formed on an antenna substrate according to an example embodiment disclosed herein. FIG. 4C is a diagram illustrating an example distribution of an electric field formed in a waveguide according to an example embodiment disclosed herein.

Referring to FIG. 4A, it can be seen that the electric field transmitted from the plurality of laminated patches 121 is centrally concentrated and highly dense due to the structure of the plurality of first pads 123 and the plurality of second pads 131. Furthermore, referring to FIG. 4B, it can be seen that the strength of the electric field formed in the region where the plurality of first pads 123 and the plurality of second pads 131 are located is weaker than the strength of the electric field in the region where the plurality of laminated patches 121 are located. In other words, the plurality of first pads 123 and the plurality of second pads 131 effectively prevent the signal transmitted through the plurality of laminated patches 121 from being dispersed to the outside, so that the signal is transmitted in a concentrated manner.

Furthermore, the distribution of the electric field of the signal transmitted through the antenna substrate 10 into the waveguide 20 is shown in FIG. 4C. Referring to FIG. 4C, it can be seen that the signal is transmitted to the waveguide 20 with a strong intensity without loss, due to the structure of the antenna substrate 10 according to the example embodiments disclosed herein. Furthermore, it can be seen that the electric field is well converted between the TEM mode, which is the mode of operation of the antenna substrate 10, and the TE mode, which is the mode of operation of the waveguide, due to the electric field regulation through the plurality of first pads 123 and the plurality of second pads 131 provided on the antenna substrate 10.

As such, the antenna substrate 10 may utilize a plurality of laminated patches 121 and a plurality of first pads 123 and a plurality of second pads 131 in the laminated structure of the substrate to regulate the distribution of the electric field, thereby minimizing the loss of the signal to the waveguide 20.

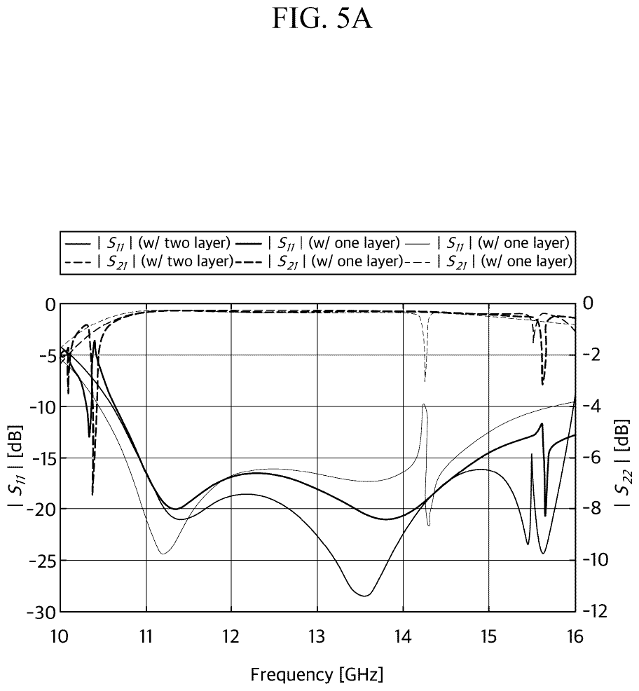

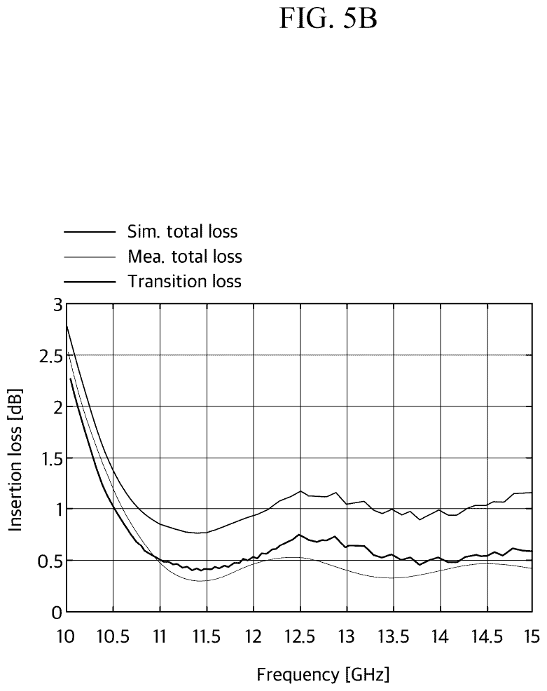

FIGS. 5A and 5B are diagrams illustrating example results of evaluating an antenna substrate according to an example embodiment disclosed herein.

First, FIG. 5A shows the insertion loss |S₂₁| and reflection coefficient |S₁₁| as a function of signal frequency of an antenna substrate. In FIG. 5A, the insertion loss and reflection coefficient are shown as a function of the number of layers having pads to regulate the electric field, and the units of both the insertion loss and reflection coefficient are dB.

Here, the reflection coefficient may mean a measure of the degree to which an input signal is reflected internally, and the insertion loss may mean a measure of the degree of loss due to absorption by an internal structure or the like. For example, the insertion loss may be a measure of the strength of the output signal relative to the strength of the input signal.

Referring to FIG. 5A, it can be seen that the case without pads (w/o layer) and the case with one layer of pads (w/ one layer) have large insertion losses in certain frequency bands. The case without pads has a large insertion loss of less than −3 dB at around 14.2 GHz, and the case with one layer of pads has a large insertion loss of less than −3 dB at around 15.6 GHz. In contrast, when the pad is composed of two layers (w/ two layer), it shows stable insertion loss performance of better than −3dB in all frequency bands, indicating that the insertion loss can be improved.

Similarly, it can be seen that the reflection coefficient performance can be improved when the pad is composed of two layers, as it has a lower reflection coefficient in all frequency domains compared to cases without pads or with one layer of pads.

Next, FIG. 5B shows an example of the results of comparing the theoretical limit of insertion loss (Sim. total loss) of the antenna substrate with the actual measured value (Transition loss) and the average loss (Mea. total loss) of a typical substrate.

Referring to FIG. 5B, it can be seen that the antenna substrate 10 disclosed herein has a very small loss of less than 1 dB in the region above 10.5 GHz, and has an insertion loss close to the theoretical limit. It can also be seen that improved insertion loss performance is achieved compared to the average loss of typical substrates.

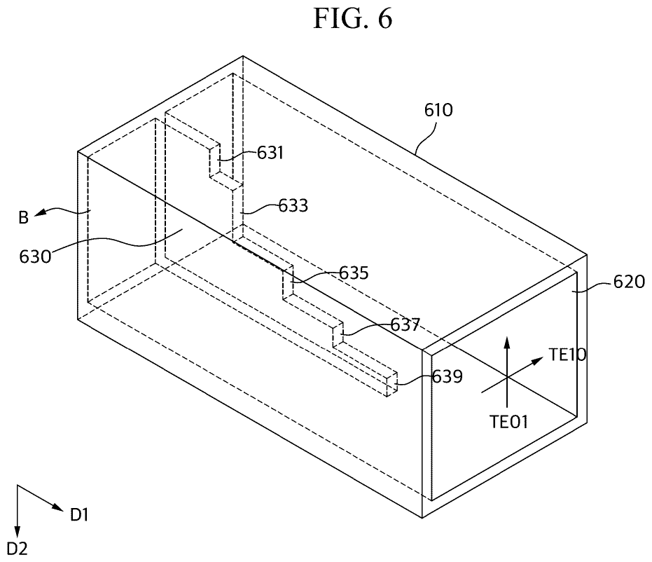

FIG. 6 is a diagram illustrating a structure of an antenna apparatus according to an example embodiment disclosed herein. Referring to FIG. 6, the antenna apparatus may include a waveguide 610 and a horn antenna 620. The antenna apparatus may be a dual circularly polarized antenna capable of simultaneously radiating and receiving left-hand circularly polarized waves (LHCP) and right-hand circularly polarized waves (RHCP).

The waveguide 610 may refer to a hollow tube made of a conductor, and may refer to a passageway for signals to travel through. The waveguide 610 may be in the form of a square column, and may extend in the first direction D1. The waveguide 610 may be hollow with a hollow center, and the horn antenna 620 may be positioned in the hollow inside the waveguide 610. The waveguide 610 shown in FIG. 6 may be distinct from the waveguide 20 coupled to the upper surface of the antenna substrate 10 of FIG. 1.

The horn antenna 620 may be coaxial with the waveguide 610, and may be located inside the waveguide 610. For example, the outer circumferential surface of the horn antenna 620 and the inner circumferential surface of the waveguide 610 may be tangential. The antenna apparatus may pass a first signal in a relatively high frequency band through the horn antenna 620 and a second signal in a relatively low frequency band through the space between the waveguide 610 and the horn antenna 620. Thus, the antenna apparatus may be utilized to transmit and receive multiband signals. For example, the first signal may be a signal in the Ku band at a relatively high frequency, and the second signal may be a signal in the X band at a relatively low frequency.

According to an example embodiment, the horn antenna 620 may include a septum 630. The horn antenna 620 may include the septum 630 to generate circular polarization in the square column-shaped waveguide 610. As used herein, polarization refers to the direction of polarization of an electric field with respect to the direction of travel of an electromagnetic wave, and circular polarization refers to a polarization in which the plane of polarization alternates between horizontal and vertical directions in a spiral fashion. There are two types of circular polarization: left-hand circular polarization (LHCP) or right-hand circular polarization (RHCP) depending on whether the direction of rotation is left or right.

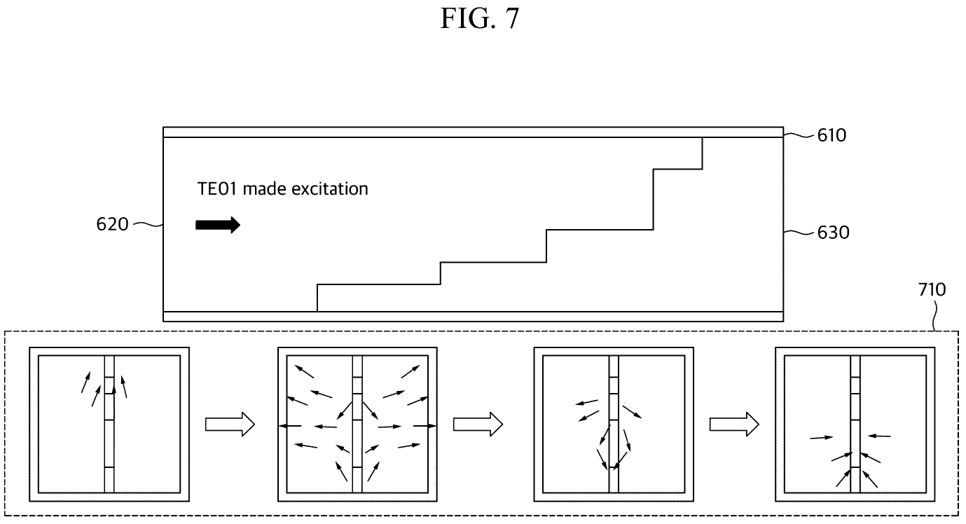

Due to the septum 630, the signal generated in TE10 mode and the signal generated in TE01 mode may have a 90 degree difference in phase, resulting in circular polarization. Here, TE mode refers to a transverse electric field mode, which is a propagation mode in which only the magnetic field component exists in the direction in which the signal is guided. Also, in TE_MN mode, M denotes the number of half-wave changes in the long axis direction and N denotes the number of half-wave changes in the short axis direction. For example, 710 in FIG. 7 shows the distribution of the electric field formed in a cross-section of the horn antenna 620, and it can be seen that the polarization direction of the electric field alternates between the horizontal and vertical directions, resulting in circularly polarized waves.

According to an example embodiment, the septum 630 may be formed based on a cross-section B on the first direction D1 side of the horn antenna to connect between two cross-sections of the horn antenna 620 facing each other in the second direction D2 perpendicular to the first direction D1 along the second direction D2. For example, the septum 630 may be formed to span a center portion of the cross-section B of the horn antenna 620.

The septum 630 may include an interior space. That is, the septum 630 may have a three-dimensional structure with a space inside. According to an example embodiment, the septum 630 may include a plurality of septum interior space portions 631, 633, 635, 637, 639 extending to different lengths in the first direction from the cross-section on which the septum is formed in the horn antenna 620. The septum interior space portions may be physically separated, or they may be conceptually separated but not physically separated. For example, the plurality of septum interior space portions may be formed as a single unit without being physically separated, but it is sufficient if an imaginary boundary between each interior space portion can be identified.

According to an example embodiment, the length of each of the plurality of septum interior space portions extending in the first direction may be formed such that the length of each of the plurality of septum interior space portions increases in the order in which the plurality of septum interior space portions are located along the second direction D2. That is, the length of the plurality of septum interior space portions extending in the first direction D1 may increase as the plurality of septum interior space portions move from the upper surface to the lower surface of the horn antenna 620.

For example, in FIG. 6, the length of the septum interior space portion 633 extending in the first direction may be longer than the length of the septum interior space portion 631 extending in the first direction. Similarly, the length of the septum interior space portion 639 extending in the first direction may be longer than the lengths of the other septum interior space portions extending in the first direction.

The length of each of the plurality of septum interior space portions extending in the first direction may be set differently depending on the operating frequency of the antenna apparatus. Further, the lengths of each of the plurality of septum interior space portions extending in the second direction may be different from each other, and may be determined according to the operating frequency of the antenna apparatus.

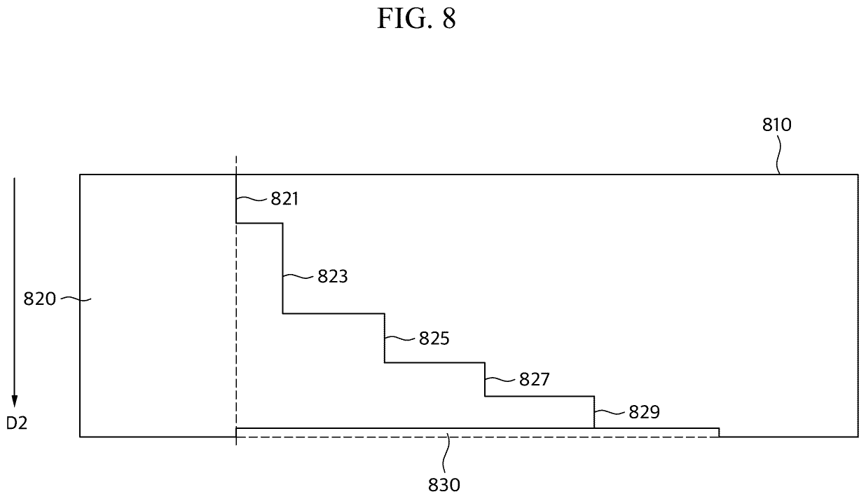

FIG. 8 is a diagram illustrating an example of an antenna apparatus including a ridge according to an example embodiment disclosed herein.

Referring to FIG. 8, the horn antenna 810 may further include a ridge 830 that is recessed inwardly of the horn antenna 810 from a lower surface of the horn antenna 810 and coupled to a lower surface of the septum 820. The ridge 830 may equally regulate the magnitude of the signal in TE10 mode and TE01 mode which form circular polarization.

For example, a length extending in the first direction of the ridge 830 may be longer than a length extending in the first direction from a starting point of formation of the ridge 830 at a lowermost located portion 829 of the septum interior space portion of the septum 820.

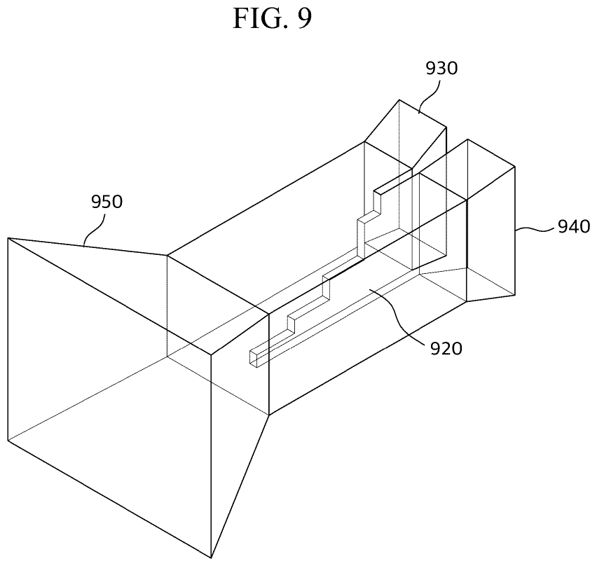

FIG. 9 is a diagram illustrating an example of an antenna apparatus including a first input port and a second input port according to an example embodiment disclosed herein.

Referring to FIG. 9, an antenna apparatus may further include a first input port 930 and a second input port 940 formed to be symmetrical to each other with respect to the septum 920, corresponding to a cross-section in which the septum 920 of the horn antenna 910 is formed. Here, the first input port 930 and the second input port 940 may refer to feed ports for generating a left-hand circularly polarized wave (LHCP) and a right-hand circularly polarized wave (RHCP), respectively.

The antenna apparatus may form dual circularly polarized waves from signals fed through the first input port 930 and the second input port 940. The antenna apparatus may further include an opening 950 for radiating a propagated signal or receiving a signal from the outside.

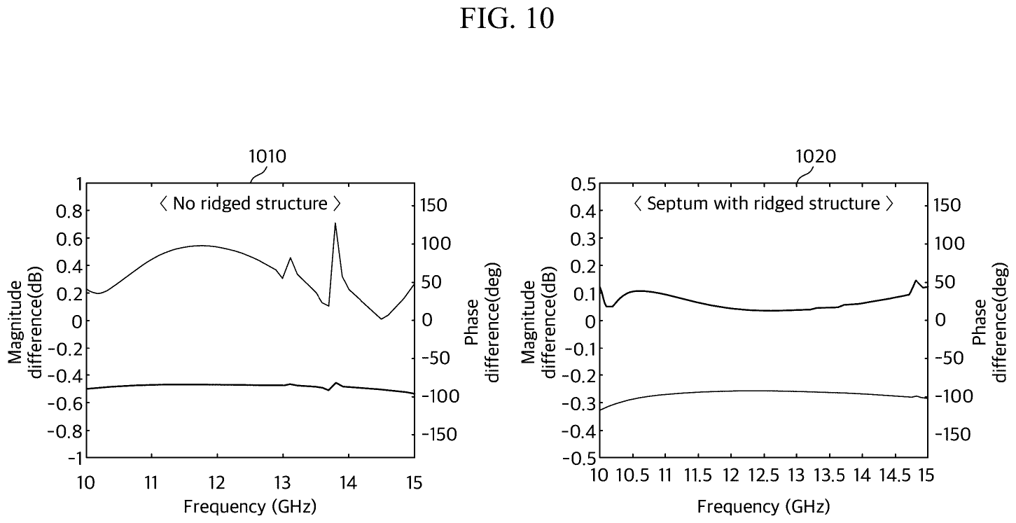

FIG. 10 is a diagram illustrating the difference in magnitude of signals generated in TE10 mode and TE01 mode with and without a ridge according to an example embodiment disclosed herein.

Referring to FIG. 10, graph 1010 is a diagram illustrating the magnitude difference and phase difference as a function of frequency of signals generated in TE10 mode and TE01 mode when no ridge is provided, and graph 1020 is a diagram illustrating the magnitude difference and phase difference as a function of frequency of signals generated in TE10 mode and TE01 mode when a ridge is provided.

Referring to graph 1010, it can be seen that when the ridge is not provided, the magnitude difference between TE10 mode and TE01 mode is large, with a magnitude difference of about 0.7 dB at about 14 GHz, and the signal magnitude difference is not uniform with frequency. In contrast, referring to graph 1020, it can be seen that when a ridge is provided, the magnitude difference between TE10 mode and TE01 mode remains uniformly below 0.1 dB in all frequency bands, which can improve the signal magnitude difference.

Also, referring to graph 1020 and graph 1010, it can be seen that when the ridge is provided, the phase difference between the TE10 mode signal and the TE01 mode signal remains more uniformly at −90 degrees, compared to when the ridge is not provided.

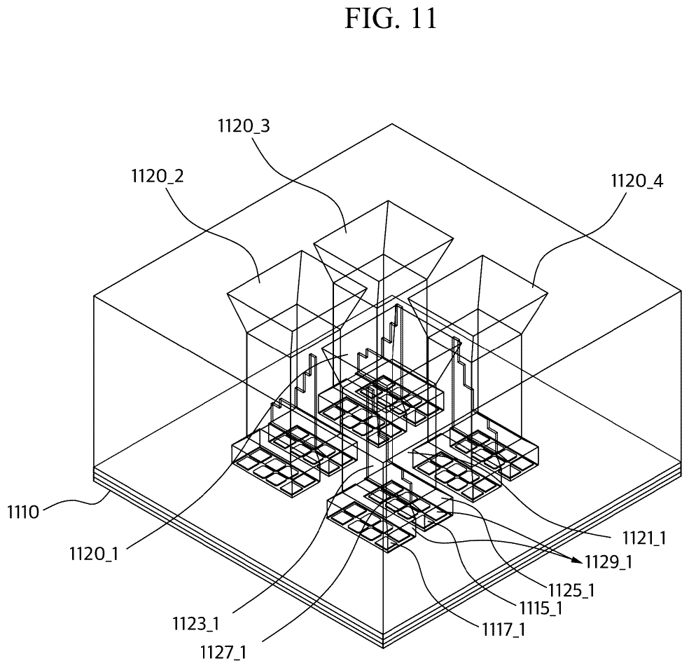

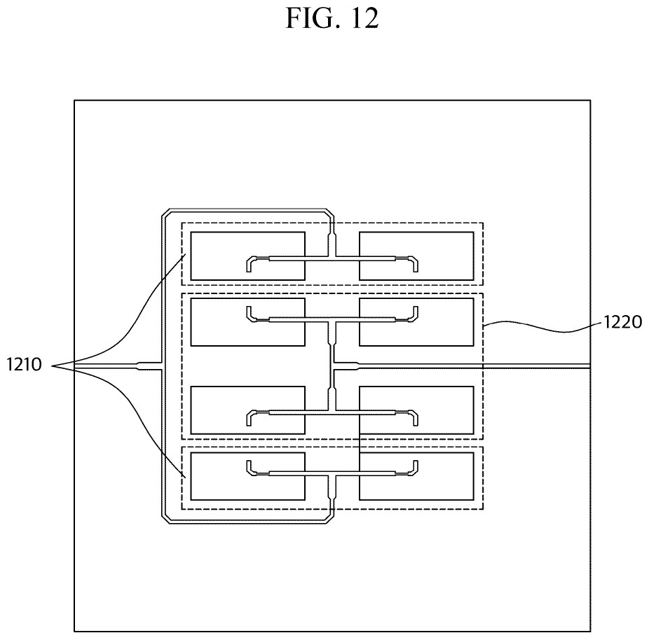

FIG. 11 is a diagram illustrating an example of a device according to an example embodiment disclosed herein. Here, the device may be, for example, a device for satellite communications and may be a device to which an array of antenna apparatuses for active beam steering is applied. The device may have, for example, a structure combining the antenna substrate shown in FIG. 1 and the antenna apparatuses shown in FIG. 6 extended in an array.

Referring to FIG. 11, the device may include a plurality of antenna apparatuses 1120_1 to 1120_4 and an antenna substrate 1110. Each of the plurality of antenna apparatuses 1120_1 to 1120_4 may be, for example, an antenna apparatus shown in FIGS. 6 to 10. The antenna substrate 1110 may be coupled to the plurality of antenna apparatuses 1120_1 to 1120_4 and may feed the plurality of antenna apparatuses 1120_1 to 1120_4.

According to an example embodiment, each of the plurality of antenna apparatuses 1120_1 to 1120_4 may include a horn antenna including a septum and a first input port and a second input port formed to be symmetrical to each other with respect to the septum corresponding to the cross-section in which the septum is formed in the horn antenna. The first input port and the second input port of each of the antenna apparatuses may be feed ports for generating a left-hand circularly polarized wave (LHCP) and a right-hand circularly polarized wave (RHCP), respectively, to form a dual circularly polarized wave in the antenna apparatus.

According to an example embodiment, the antenna substrate may be formed of a plurality of sub-antenna substrates coupled in one-to-one correspondence with input ports of each of the plurality of antenna apparatuses. Each of the sub-antenna substrates may be, for example, the antenna substrate shown in FIGS. 1 to 3.

According to an example embodiment, each of the plurality of sub-antenna substrates may be coupled to a corresponding input port through a waveguide. For example, a first antenna apparatus 1120_1 may include a horn antenna 1121_1, a septum 1123_1, a first input port 1125_1, and a second input port 1127_1, in which the first antenna apparatus 1120_1 may be coupled to the antenna substrate 1110 through a waveguide 1129_1.

In other words, the device may have high gain broadband performance by combining the antenna substrate 1110 with active circuitry for active beam steering with low loss of signal and the antenna apparatus capable of generating uniform dual circularly polarized waves, allowing radiation and reception of dual circularly polarized waves.

The arrangement and orientation of the antenna apparatuses shown in FIG. 11 is exemplary, but not limiting. For example, in FIG. 11, the septums of respective antenna apparatuses are shown to be disposed so that their lower surfaces face each other, but are not limited thereto.

FIG. 12 is a diagram illustrating an example arrangement of antenna apparatuses according to an example embodiment disclosed herein.

Referring to FIG. 12, an example of when the horn antennas are arranged in a 2×2 arrangement is shown, in which a sub-antenna substrate associated with a first input port of each antenna apparatus is disposed outside of a sub-antenna substrate associated with a second input port.

According to an example embodiment, the antenna substrate may be disposed such that each sub-antenna substrate associated with the first input port of each of the plurality of antenna apparatuses is disposed outside of each sub-antenna substrate associated with the second input port of each of the plurality of antenna apparatuses. For example, as shown in FIG. 12, each sub-antenna substrate 1210 associated with the first input port of the plurality of antenna apparatuses may be disposed outside of each sub-antenna substrate 1220 associated with the second input port of the plurality of antenna apparatuses.

For example, signals for forming left circularly polarized waves may be supplied to a plurality of antenna apparatuses through the sub-antenna substrate disposed on the outside, and signals for forming right circularly polarized waves may be supplied to a plurality of antenna apparatuses through the sub-antenna substrate disposed on the inside.

By arranging the sub-antenna substrates in this manner, the signals for forming left circularly polarized waves and right circularly polarized waves may be isolated and fed to each antenna apparatus, thereby increasing the reflection coefficient and isolation performance of the device and improving the axial ratio performance of the dual circularly polarized signal.

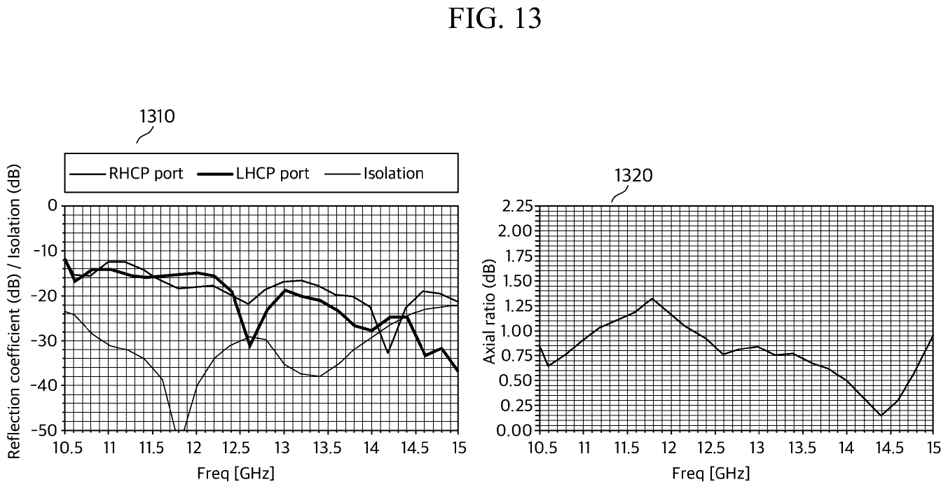

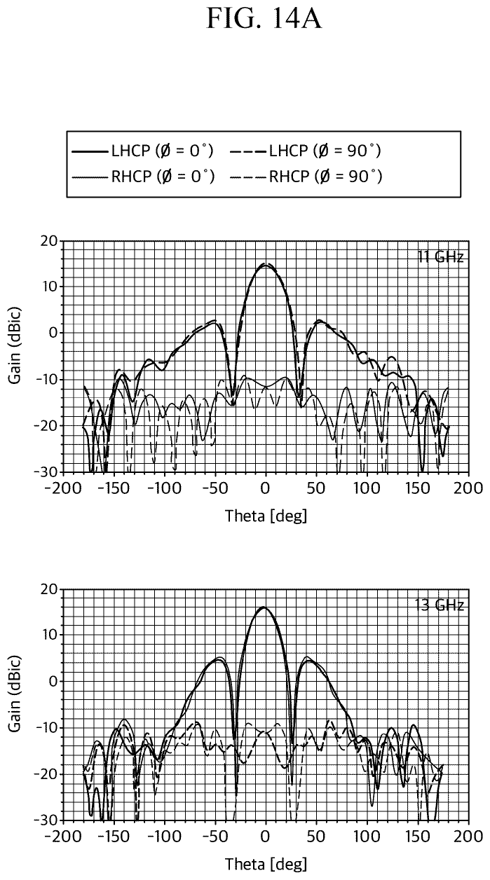

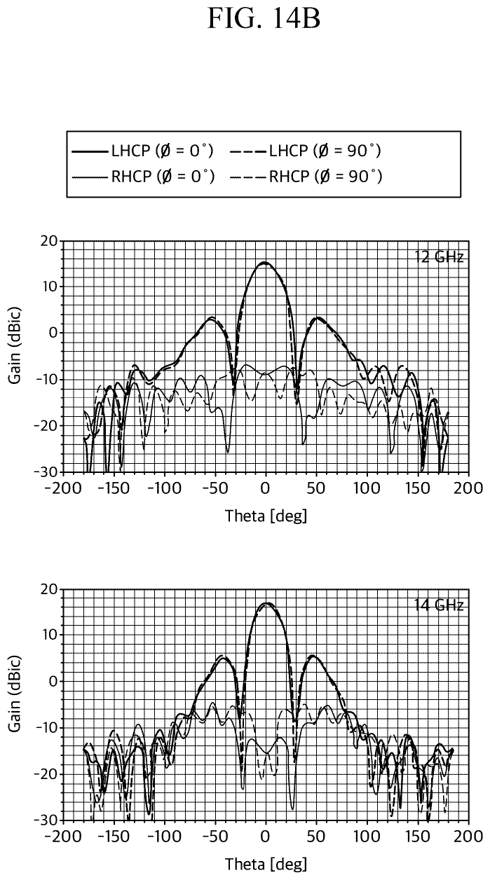

FIG. 13 is a diagram illustrating an example of a performance evaluation according to an arrangement of apparatuses according to an example embodiment disclosed herein. FIG. 13 illustrates the reflection coefficient, isolation between ports, and axial ratio when the apparatuses are arranged as shown in FIG. 12.

First, referring to graph 1310 in FIG. 13, it can be seen that the reflection coefficients of the right circularly polarized wave port and the left circularly polarized wave port are similar in the 10.5 GHz to 14.5 GHz band, and have very high isolation of greater than 20 dB at all operating band frequencies. Furthermore, referring to graph 1320 in FIG. 13, it can be seen that the performance is very good, less than 1.25 dB at all operating band frequencies. Here, the axial ratio can mean the ratio of the intensity of the left circularly polarized wave to the right circularly polarized wave.

In other words, by arranging the antenna apparatuses and the sub-antenna substrates as shown in FIG. 12, it can be confirmed that the left circularly polarized wave to the right circularly polarized wave can be uniformly formed.

FIGS. 14A and 14B illustrate example frequency-dependent gains of a device according to an example embodiment disclosed herein. FIGS. 14A and 14B illustrate the gain of the device when it is arranged as shown in FIG. 12.

Referring to FIGS. 14A and 14B, it can be seen that the device can achieve a high gain of about 14 to 16 dBic in the frequency band. Here, dBic is a unit representing isotropic gain for circularly polarized waves.

As described above, devices for satellite communications implemented in accordance with the example embodiments disclosed herein may be used in array antennas for communications on military satellites or in antennas for radar/electronic warfare systems because they are capable of transmitting high-powered signals with broadband characteristics. Military satellites including devices according to example embodiments disclosed herein may have increased transmission capacity through frequency band widening and application of higher order modulation, thereby maintaining good communication quality even in poor propagation environments, and ensuring surveillance and reconnaissance, command and control, information exchange between precision strike systems, and command and control between tactical maneuvers.

The apparatus or terminal according to the above-described example embodiments may include a processor, a memory for storing and executing program data, a permanent storage such as a disk drive, a communication port for communicating with an external device, a user object device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, Python, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of software routines in connection with a processor or the like.

It will be apparent to those skilled in the art that various modifications and variations can be made in the embodiments of the present invention without departing from the spirit or scope of the invention. Thus, it is intended that the embodiments of the present invention cover the modifications and variations of this invention provided they come within the scope of the appended claims and their equivalents.

What is claimed is:

1. An antenna substrate comprising:
a first substrate comprising a feed line and a drive patch carrying a signal received via the feed line;
a second substrate laminated on top of the first substrate and comprising a plurality of laminated patches carrying the signal and a plurality of first pads disposed outside of the plurality of laminated patches; and
a third substrate laminated on top of the second substrate and comprising a plurality of second pads coupled to the plurality of first pads.

2. The antenna substrate of claim 1, wherein
the plurality of second pads are disposed on a third coupling surface of the third substrate where an upper surface of the third substrate is coupled to a waveguide,
the plurality of laminated patches and the plurality of first pads are formed to protrude upwardly on the second substrate to correspond to the third coupling surface, and
the drive patch is disposed on a first coupling surface of the first substrate corresponding to the third coupling surface.

3. The antenna substrate of claim 2, wherein
the first coupling surface and the third coupling surface are square planes,
the plurality of second pads are disposed to correspond to corners of the third coupling surface, and
the plurality of first pads are disposed on the second substrate to correspond to positions of the plurality of second pads.

4. The antenna substrate of claim 1, wherein the plurality of first pads and the plurality of second pads are coupled through vias.

5. An antenna apparatus comprising:
a waveguide having a square column extending in a first direction; and
a horn antenna located inside the waveguide in a coaxial configuration with the waveguide and comprising a septum,
wherein the septum is formed based on a cross-section on a first direction side of the horn antenna to connect between two cross-sections of the horn antenna facing each other in a second direction perpendicular to the first direction along the second direction.

6. The antenna apparatus of claim 5, wherein the septum comprises a plurality of septum interior space portions extending to different lengths in the first direction from the cross-section of the horn antenna where the septum is formed.

7. The antenna apparatus of claim 6, wherein a length of each of the plurality of septum interior space portions extending in the first direction is formed to increase in an order in which the plurality of septum interior space portions are located along the second direction.

8. The antenna apparatus of claim 6, wherein the horn antenna further comprises a ridge recessed from a lower surface of the horn antenna in an inward direction of the horn antenna and coupled to a lower surface of the septum.

9. The antenna apparatus of claim 6, further comprising a first input port and a second input port formed to be symmetrical to each other with respect to the septum corresponding to the cross-section where the septum of the horn antenna is formed.

10. A device comprising:
a plurality of antenna apparatuses; and
an antenna substrate coupled to the plurality of antenna apparatuses and feeding the plurality of antenna apparatuses, wherein
each of the plurality of antenna apparatuses comprises:
a horn antenna comprising a septum; and
a first input port and a second input port formed to be symmetrical to each other with respect to the septum corresponding to a cross-section where the septum of the horn antenna is formed,
the antenna substrate is formed of a plurality of sub-antenna substrates coupled in one-to-one correspondence with input ports of each of the plurality of antenna apparatuses, and
each of the plurality of sub-antenna substrates is coupled to a corresponding input port through a waveguide.

11. The device of claim 10, wherein each sub-antenna substrate of the antenna substrate corresponding to the first input port of each of the plurality of antenna apparatuses is disposed outside of each sub-antenna substrate corresponding to the second input port of each of the plurality of antenna apparatuses.
